(19) United States
(12) Patent Application Publication
(10) Pub. No.: US 2026/0104612 A1
(43) Pub. Date: Apr. 16, 2026

(54) BACKLIGHT SYSTEM FOR THREE-DIMENSIONAL PRINTING APPARATUS

(71) Applicant: SprintRay, Inc., Los Angeles, CA (US)

(72) Inventors: Jing Zhang, Los Angeles, CA (US); Navy Pan, Shaoxing (CN); Chunhui Wang, Shaoxing (CN)

(21) Appl. No.: 19/360,923

(22) Filed: Oct. 16, 2025

Related U.S. Application Data
(60) Provisional application No. 63/707,783, filed on Oct. 16, 2024.
(60) Provisional application No. 63/831,944, filed on Jun. 27, 2025.

(51) Int. Cl. G02F 1/13357; B29C 64/264; B33Y 30/00

(52) U.S. Cl. CPC G02F 1/133606; B29C 64/264; B33Y 30/00

(57) ABSTRACT

A light control system for use with three-dimensional printing systems includes dedicated lenses disposed between backlight source elements and an LCD display. The lenses each include an upper convex surface and a lower concave surface. The upper convex surfaces may each include a central recess. Each lens's upper surface, lower surface, and/or central recess may cause light passing through the respective lens to further diverge thereby forming an annular band of light delivered by the lens to the LCD display as backlight. The annular bands of light provided by the plurality of such lenses may combine at the LCD display to fill any gaps or areas of lower intensity or insufficient curing light that may potentially cause visible transition lines on a resulting 3D-printed object. In this way, such visible blemishes may be reduced or eliminated.

### PRIORITY AND RELATED APPLICATIONS

This application claims priority to U.S. Provisional Application No. 63/831,944, filed on Jun. 27, 2025, and also claims priority to U.S. Provisional Application No. 63/707,783, filed on Oct. 16, 2024, the disclosure of each incorporated by reference in their entirety.

### TECHNICAL FIELD

The present invention generally relates to the field of three-dimensional (3D) printers, including a backlight system for use in 3D printers and/or additive manufacturing systems.

### BACKGROUND

Liquid crystal displays (LCDs) are used throughout the world as illumination sources for three-dimensional printers. Such LCDs typically receive backlighting, e.g., from an associated array of light emitting diodes (LEDs), and the resulting light emitted by an LCD panel is directed to the building area within a resin tank to cure the object being printed layer-by-layer.

However, each individual LED element in the array of backlighting LEDs may oftentimes not be controllable in real time. As such, an entire array of LEDs may be turned on even if only a portion of the backlighting provided by the array is needed to cure a particular layer of resin. As a result, the power consumption of the LED array may be unnecessarily high.

In addition, if the LEDs are controllable, this control typically only includes the ability to toggle the LED elements on and off, e.g., in zones. Such control, while an improvement over no control at all, oftentimes leads to a jagged texture at the boundaries of the layered patterns of the 3D printed object, thereby reducing the surface quality of the printed part.

Furthermore, gaps or areas of lesser intensity or insufficient curing light between portions of light delivered to the LCD screen from separate adjacent LEDs may cause visible transition lines on the 3D-printed object, e.g., on the object's outer surface, thereby adversely affecting the quality and appearance of the object.

Accordingly, there is a need for a system and method to dynamically control light intensity parameters of particular LEDs within an array of backlighting LEDs. There also is a need for a system and method of dynamically controlling individual LCD pixels within an LCD panel to further optimize the curing light used during the 3D printing process. There also is a need for a system that reduces or eliminates areas of insufficient curing light between adjacent portions of light delivered to an LCD panel by separate adjacent backlighting LEDs.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 shows a perspective view of a dynamic light control system in some embodiments of the present invention.

FIG. 2 shows an exploded view of a dynamic light control system in some embodiments of the present invention.

FIG. 3 shows a sectional view of a dynamic light control system in some embodiments of the present invention.

FIG. 4 shows a detail view of a portion of FIG. 3 in some embodiments of the present invention.

FIG. 5 shows aspects of a dynamic light control system in some embodiments of the present invention.

FIG. 6 shows aspects of an LCD display in some embodiments of the present invention

FIGS. 7-9 show representations of an array of LCD pixels in some embodiments of the present invention.

FIG. 10 shows a representation of an array of LED pixels in some embodiments of the present invention.

FIG. 11 shows a representation of light emitting from two side-by-side lenses in some embodiments of the present invention.

FIG. 12 shows a perspective view of a light control system in some embodiments of the present invention.

FIG. 13 shows an exploded view of a backlight assembly in some embodiments of the present invention.

FIG. 14 shows a sectional view of light passing through a lens in some embodiments of the present invention.

FIG. 15 shows a sectional view of light being delivered from a backlight assembly to an LCD assembly in some embodiments of the present invention.

FIG. 16 shows an annular band of light being delivered from a backlight assembly to an LCD assembly in some embodiments of the present invention.

FIG. 17 shows a graph of light intensity vs. light position in some embodiments of the present invention.

FIGS. 18A and 18B show layouts of light emitting elements in some embodiments of the present invention.

FIG. 19 shows a pattern of light emitting onto an LCD display in some embodiments of the present invention.

### DETAILED DESCRIPTION OF EXEMPLARY EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

In general, a system and method of dynamic light control is provided for use with three-dimensional (3D) printing systems. The dynamic light control system and method includes an array of light emitting diodes (LEDs) configured to provide controlled backlighting to a liquid crystal display (LCD) during a 3D printing process. By controlling the light intensity of the individual LEDs as well as the LCD pixel elements in real time during the 3D printing process, the quality of the 3D printed object (e.g., its surface quality) may be improved. In addition, power consumption of the associated 3D printing system also may be better managed.

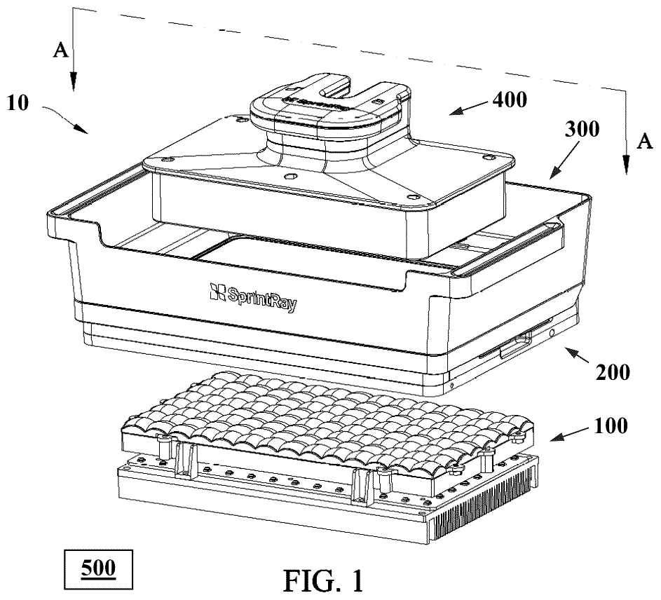

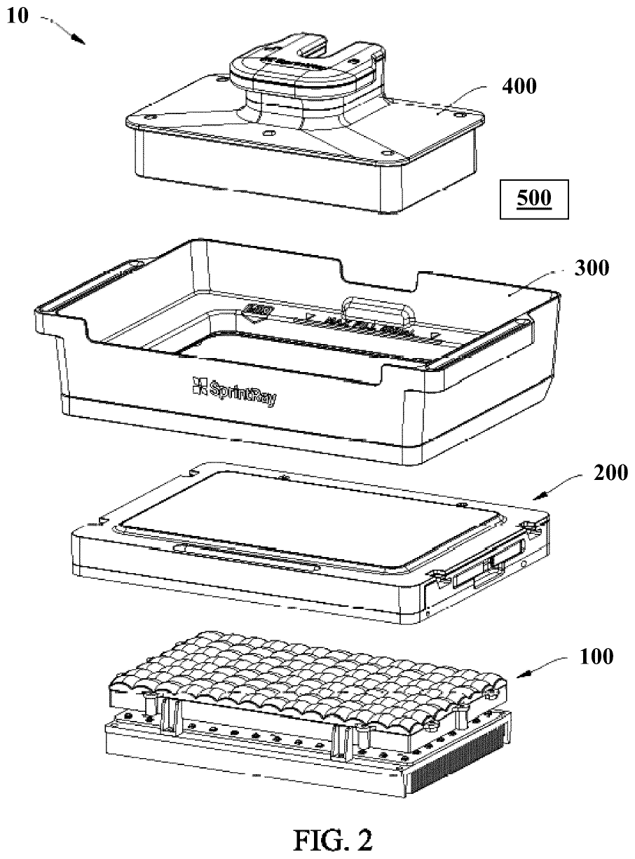

FIG. 1 shows a perspective view of a dynamic light control system 10 and FIG. 2 shows an exploded view of the same.

In some embodiments, as shown in FIGS. 1 and 2, the dynamic light control system 10 (also referred to herein as simply the system 10) includes a backlight assembly 100, an LCD assembly 200, a resin tank 300, a build platform 400, and a controller 500. In general, and in some embodiments, the backlight assembly 100 may include an array of LED elements 120 to provide back lighting to the LCD assembly 200. The LCD assembly 200 may receive the backlight, modify it further, and provide it to the build platform 400 within the resin tank 300 to cure a layer of resin during a 3D printing process. The dynamic light control system 10 also may include other elements and/or components as necessary to perform its functionalities.

A three-dimensional digital model of the object being 3D printed may be provided. The model may be digitally “sliced” to convert the model into a set of individual layers that, when printed sequentially on top of one other, may form the object.

During the 3D printing process, the sliced model is used to determine printing instructions for each layer (e.g., using machine language such as geometric code (G-code) or similar). Instructions for each layer may generally include a representation of the shape and form of the object being printed at the respective cross-section of the layer and may be referred to herein as layer patterns. As described herein, the system 10 then uses the layer patterns to control the backlight assembly 100 and the LCD assembly 200 to provide light in the correct pattern, shape, intensity, and form as required to print each particular layer, one after another. For example, the system 10 may utilize the layer patterns to dynamically control the on/off state and/or the light intensity of each LED element 120 in the backlight assembly 100 for each layer. In another example, the system 10 may control the LCD assembly 200 to further modify the light as the light passes through the LCD assembly 200. In this way, the system 10 may in real time optimize the characteristics of the light used to cure each layer of the object during the 3D printing process. This will be described in further detail in other sections.

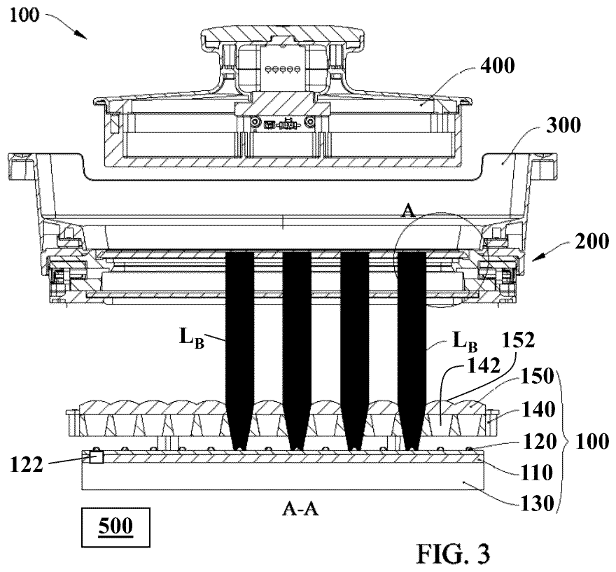

FIG. 3 shows a side sectional view of the system 10 taken along cutlines A-A of FIG. 1.

In some embodiments, as shown in FIG. 3, the backlight assembly 100 includes a baseplate 110, one or more LED elements 120 mounted to the base plate 110, one or more heat dissipating members 130, a baffle 140, and a lens module 150.

In some embodiments, the baseplate 110 includes mechanisms necessary to receive, mount, operate, and control each LED element 120. The LED elements 120 may include UV-LEDs (or other suitable types) and may be arranged in one or more arrays on the base plate 110. For example, the LEDs 120 may be arranged in a 14×8 array of 112 LED elements 120, in a 14×7 array of 98 LED elements 120, in a 12×6 array of 72 LED elements 120, and/or in any other sizes and/or configurations of arrays and/or suitable arrangements. In some embodiments, the numbers and/or arrays of LED elements 120 may be adjusted according to specific 3D printing needs to optimize system operating parameters such as energy consumption, etc.

In some embodiments, each LED element 120 may include an integrated internal or external control device 122 configured to enable control of the LED's one or more parameters. For example, each LED element 120 may include a potentiometer, a digital controller, a voltage regulator (e.g., such as a pulse-width modulation device (PWM)), and/or other suitable control device(s) 122 configured to control the respective LED's on/off state and/or output power (e.g., the light intensity). Each control device 122 may be configured with and controlled by the system controller 500 which may control the LEDs 120 in real time during the 3D printing process per the 3D object's digital model. This will be described in detail in other sections.

In some embodiments, as shown in FIG. 3, the one or more heat dissipating members 130 may be configured with the baseplate 110 (e.g., beneath) and/or with the LEDs 120 directly to extract and dissipate heat generated by the LED elements 120 during operation. The heat dissipating members 130 may include heat dissipating fins, plates, heat sinks, other suitable types of heat dissipating members, and/or any combinations thereof.

In some embodiments, as shown in FIG. 3, the baffle 140 may be configured above the base plate 110 and LED elements 120 and may be designed to receive light emitted by each LED 120. In some embodiments, the baffle 140 may include one or more light guides 142, with each light guide 142 preferably configured with (e.g., aligned vertically above) a corresponding LED element 120. As such, each light guide 142 may receive light emitted from its corresponding LED 120 and guide the light accordingly, e.g., into the bottom and out the top of each guide 142. Given this, it may be preferable that the baffle 130 include at least one light guide 142 for each LED element 120 on the baseplate 110, and more preferably, a matching number of light guides 142 and LEDs 120. That is, there may preferably be a one-to-one correspondence between the light guides 142 and the corresponding LED elements 120.

In some embodiments, the light guides 142 may each comprise a passageway through which the corresponding light may travel. In some embodiments, as shown in FIG. 3, the light guide passageways may be generally funnel-shaped with a lower diameter (e.g., at the lower entrance to the light guide 142) being smaller than an upper diameter (e.g., at the upper exit from the light guide 142). In other embodiments, the passageways may be generally cylindrical, inverted funnel-shaped, and/or otherwise shaped. It may be preferable that the light guides 142 generally match one another (e.g., in shape and size), however, in other embodiments, some light guides 142 may include unique aspects compared to other light guides 142.

In some embodiments, the light guides 142 may preferably each include a horizontal cross-section that is circular, however, other cross-sectional shapes such as square, oval, polygonal, and/or other suitable shapes also are contemplated.

In some embodiments, as shown in FIG. 3, the lens module 150 may be configured above the baffle 140 and may include an array of lenses 152, with each lens 152 in the array preferably configured with (e.g., aligned vertically above) a corresponding light guide 142. As such, each lens 152 may receive light emitted from its corresponding light guide 142 and modify the light accordingly. Given this, it may be preferable that the lens array include at least one lens 152 for each light guide 142, and more preferably, a matching number of lenses 152 and light guides 142. That is, there may preferably be a one-to-one correspondence between the lenses 152 and the corresponding light guides 142.

In some embodiments, each lens 152 is designed to modify the light it may receive from its corresponding light guide 142. For example, in some embodiments, the light emitted from each light guide 142 may be generally divergent, and each corresponding lens 152 may be designed to collimate the divergent light it may receive. In this way, the aggregate light that emits from the upper output side of the lens module 150 may include predominantly collimated light. As described below, the collimated light may then be provided to the LCD assembly 200 as backlighting.

For the purposes of this specification, light emitted by an individual LED element 120 that passes through a corresponding light guide 142 and a corresponding lens 152 to become backlight L_{B} may be referred to as a backlight cell C_{B}. As will be described in other sections, each LED element 120 may be turned on/off and/or otherwise modified depending on whether the layer pattern being printed requires light from the corresponding backlight cell C_{B}.

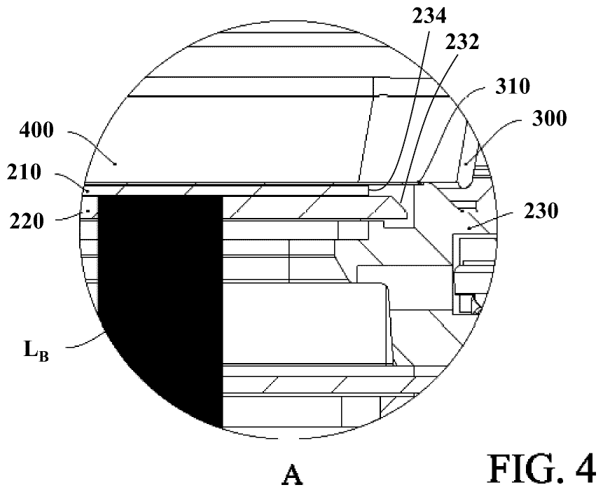

FIG. 4 shows a close-up detail view of the portion A of FIG. 3.

In some embodiments, as shown in FIG. 4, the LCD assembly 200 includes an LCD screen module 210, a transparent support layer 220 (e.g., glass), and a frame assembly 230. In general, the LCD screen module 210 and the support glass 220 may be configured beneath the resin tank 300 using the frame assembly 230.

In some embodiments, the LCD screen module 210 receives the backlighting L_{B} from the backlight assembly 100 and modifies the backlighting L_{B} per the digital model of the object being 3D printed (e.g., per each layer pattern). For example, in some embodiments, the LCD screen module 210 is controlled by the controller 500 to allow the collimated backlight L_{B} to pass through the LCD screen module 210 in certain areas or zones while preventing the collimated backlight L_{B} from passing through other certain areas or zones. The specific areas or zones of emitted and/or of blocked light may be based upon (at least in part) the digital model of the object being 3D printed (e.g., on the layer patterns) as described in other sections.

In some embodiments, the pixel density of the LCD screen module 210 may be higher than the density of the LED elements 120 in the backlight assembly 100. For example, the LCD screen module 210 may include 2K, 4K, 8K, and/or other resolutions depending on the required parameters of the object being 3D printed. Using a 4K resolution as an example, the LCD screen module 210 may typically feature about 3,840×2,160 pixels. In comparison, the backlight assembly 100 may generally include about 112, 98, 72, or another suitable quantity of LED elements 120. This may imply that a single LED element 120 may correspond to dozens or even hundreds of pixels on the LCD screen module 210. As described in detail in other sections, this higher LCD pixel resolution may enable the LCD screen module 210 to modify the backlight L_{B} it receives at a higher resolution.

In some embodiments, the frame assembly 230 includes a dedicated support structure configured to receive and secure the LCD assembly 200 beneath the resin tank 300. To do so, the frame assembly 230 may include an inner aperture (through which the curing light may pass) generally surrounded (at least partially) by a first peripheral notch 232 (or slot, step, recess, etc.) and a second peripheral notch 234 (or slot, step, recess, etc.) above the first notch 232. In some embodiments, the first notch 232 may be designed to receive a peripheral portion of the support glass 220 and the second notch 234 may be designed to receive a peripheral portion of the LCD screen module 210. The first peripheral notch 232 may be configured below the second peripheral notch 234 to position the support glass 220 below the LCD screen module 220. In this way, the support glass 220 may provide support to the bottom of the LCD screen module 220.

It may be preferable that the first and second notches 232, 234 be dimensioned to receive peripheral portions of the support glass 220 and LCD screen module 210, respectively, while leaving an adequate inner portion of each of the support glass 220 and LCD screen module 210 unobstructed and aligned with the frame's inner aperture to allow the backlight L_{B} to pass through the LCD assembly 200 and to the build platform 400 within the resin tank 300 without obstruction. It also may be preferable that the first and second peripheral notches 232, 234 entirely encircle (or at least an adequate portion thereof) the support glass 220 and the LCD screen module 210, respectively, to ensure that the support glass 220 and the LCD screen module 210 are held secure and in alignment.

In some embodiments, a sheet of tempered glass (or other suitable material) may be placed on top of the LCD screen module's upper surface to protect the upper surface, to serve as an upper surface to the LCD assembly 200, and to thereby extend the assembly's service life. In some embodiments, it may be preferable that the tempered glass be placed in physical contact with the upper surface of the LCD screen module 210. It also is contemplated that any other types of layer(s) of lamination(s) and/or membrane(s) may be configured with the LCD screen module 210.

In some embodiments, the LCD assembly 200 may include a cartridge architecture that may enable portions of the assembly 200 (e.g., the LCD screen module 210) to be easily removed and/or replaced. For example, in some embodiments, the LCD assembly 200 may include the removable cartridge assembly and corresponding cradle assembly as described in U.S. patent application Ser. No. 18/244,820, filed on Sep. 11, 2023, the entire contents of which is hereby fully incorporated herein by reference for all purposes. In this way, the LCD screen module 210 (e.g., as a quick-release cartridge) may be easily removed from the system 10 for replacement, maintenance, etc., and subsequently, a new and/or refurbished LCD screen module 210 (a new cartridge) may be easily installed into the system 10.

In some embodiments, as shown in FIG. 4, the resin tank 300, configured directly above the LCD assembly 200, includes a release film 310 which may form the bottom surface of the resin tank 300. The release film 310 may enable the separation of the object being 3D printed during the 3D printing process. In some embodiments, the release film 310 may be attached to the LCD screen module 210, to the sheet of tempered glass configured above the LCD module 210, and/or to other suitable locations on the system 10 and/or associated 3D printer.

### Dynamic Light Control

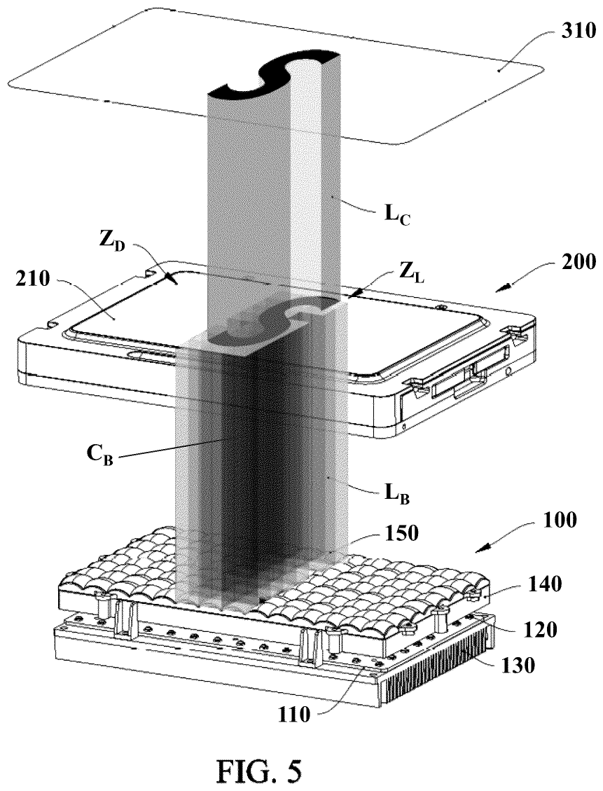

FIG. 5 shows a perspective view of the backlight assembly 100, the LCD assembly 200, and the release film 310, each shown separated from one another for clarity.

For demonstration, FIG. 5 shows the system 10 providing lighting (e.g., backlight L_{B} and curing light L_{C}) for a layer pattern in the shape of an “S”. In this example, the controller 500 has provided the S-shaped layer pattern to the backlight assembly 100 and to the LCD assembly 200. Accordingly, the backlight assembly 100 is shown providing backlight L_{B} comprising backlight cells C_{B} that contain the S-shaped pattern. That is, for each backlight cell C_{B} that includes at least a portion of the S-shaped pattern (even if the portion is very small), the system 10 may cause the corresponding LED elements 120 to be turned on. LED elements 120 corresponding to backlight cells C_{B} that do not include at least a portion of the S-shaped pattern may be turned off. This may result in lit radiation zones Z_{L} (comprising the backlight cells C_{B} that contain portions of the S-shaped pattern) and dark zones Z_{D} (in areas that do not contain any portions of the S-shaped pattern) to be incident onto the underside surface of the LCD screen module 210. As shown, the lit radiation zones Z_{L} may generally comprise a grouping of generally rectangular backlight cells C_{B} with the entire S-shaped pattern contained therein. In other embodiments, the intensity of each activated LED element 120 also may be dynamically controlled depending on the layer pattern. This will be described in detail in later sections.

Next, the LCD assembly 200 may further refine the backlight L_{B} into higher resolution curing light L_{C}. The curing light L_{C} may then be provided to the build platform 400 within the resin tank 300 to cure a layer of resin.

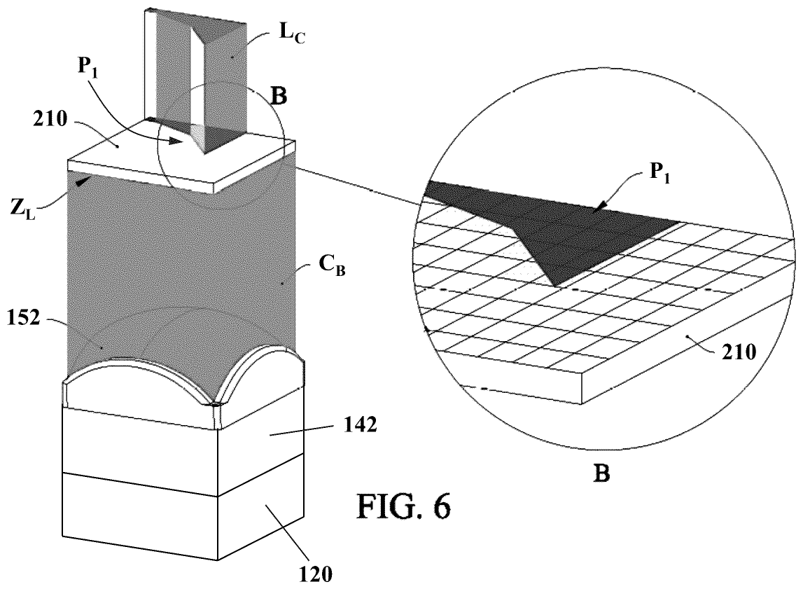

FIG. 6 shows a single backlight cell C_{B} emitting from a single LED element 120, light guide 142, and lens 152 combination. As shown, a portion P1 of the S-shaped pattern is included in the backlight cell C_{B} and as such, the corresponding LED element 120 has been turned on.

As shown in the close-up detail view B of FIG. 6, because the LCD screen module 210 may include a higher pixel density than the density of the LED elements 120 in the backlight assembly 100, the single backlight cell C_{B} may be divided into a two-dimensional array of LCD pixel elements within the LCD screen module 210. As will be described in detail below, each pixel element that includes at least a portion of the S-shaped pattern (even if the portion is very small) may be controlled to allow the backlight L_{B} associated with the pixel element to pass through the LCD screen module 210 to be transmitted to the build platform 400 within the resin tank 300. In addition, pixel elements that do not include any portion of the S-shaped pattern may be controlled to disallow the associated backlight L_{B} to pass through the LCD screen module 210. Returning to FIG. 5, the resulting higher resolution S-shaped image is then projected onto the release film 310 to cure the layer of resin.

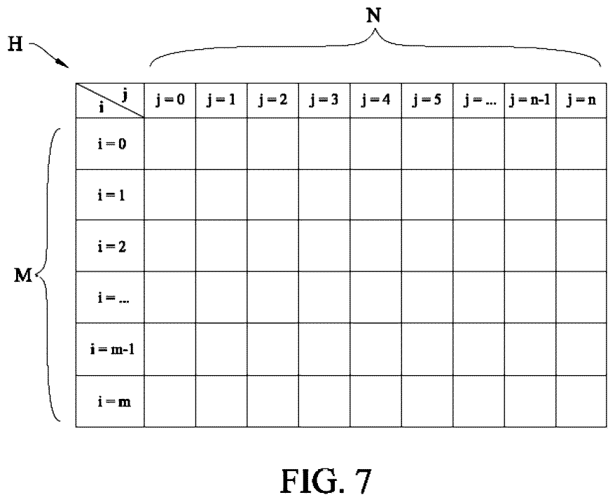

FIG. 7 shows an exemplary two-dimensional array H that may represent the LCD screen module 210 divided into M×N LCD pixel elements H (m, n). In some embodiments, the dimensions M and N may be based on the resolution and size of the LCD screen module 210 being used. For example, if the LCD screen module 210 includes a 4K resolution, M may equal 3,840 and N may equal 2,160. It is understood that these example resolutions are for demonstrational purposes and are not limiting in any way.

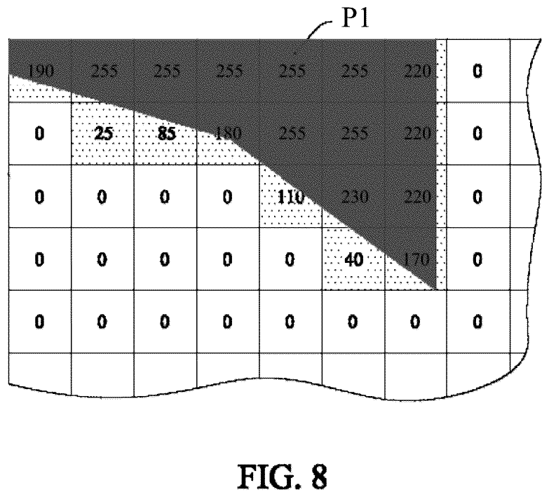

FIG. 8 shows a portion of the array H of FIG. 7, e.g., the portion generally shown in the close-up detail view B of FIG. 6 that includes the portion P1 of the S-shaped pattern. As shown, each individual pixel element H (m, n) that includes at least a portion of the portion P1 may be controlled to allow the backlight L_{B} associated with the pixel element H (m, n) to pass through the LCD screen module 210. Pixel elements H (m, n) that do not include at least a portion of the portion P1 may be controlled to disallow backlight L_{B} in these pixels to pass through the module 210.

In some embodiments, as shown in FIG. 8, the layer pattern (i.e., the portion P1) may include a grayscale image such that each pixel element H (m, n) within the array H associated with the portion P1 may be emitted according to a unique associated grayscale value G (m, n). In some embodiments, the associated grayscale value G (m, n) for each pixel element H (m, n) (shown as numbers within each corresponding element in FIG. 8) may be based on how much of the respective pixel element H (m, n) is associated with the portion P1. As such, even though an entire pixel element H (m, n) associated with the portion P1 may be illuminated, the element H (m, n) may be illuminated at varying intensities depending on its associated grayscale value G (m, n). This may result in improved energy consumption as well as smoother boundaries on the printed part.

In some embodiments, each grayscale value G (m, n) may be determined by traversing each particular pixel element H (m, n) to determine the element's coverage, where:

$$G ( m , n ) ∈ ( 0 , 255 ) \qquad ( 1 )$$

For example, if 100% of a particular pixel element H (m, n) is associated with the portion P1, then the grayscale value G (m, n) for that particular element H (m, n) may equal 255. In another example, if about 40% of a particular pixel element H (m, n) is associated with the portion P1, then the grayscale value G (m, n) for that particular element H (m, n) may equal 102. In a further example, if 0% of a particular pixel element H (m, n) is associated with the portion P1, then the grayscale value G (m, n) for that particular element H (m, n) may be zero. By controlling the LCD pixel elements H (m, n) to emit curing light according to their individual grayscale values G (m, n), the boundaries of the resulting cured layer pattern may be smoothed.

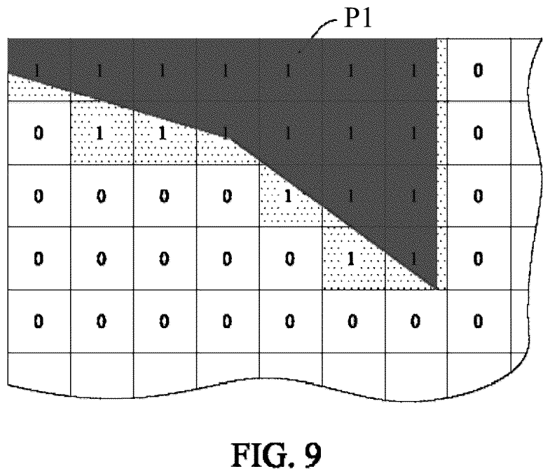

In some embodiments, as shown in FIG. 9, the grayscale values G (m, n) of each pixel element H (m, n) may be binarized using the following:

$$If G ( m , n ) \geq T then H ( m , n ) = 1 ; \qquad ( 2 )$$

where T=a predetermined grayscale threshold value,
thereby allowing the pixel H (m, n) to pass the light through the LCD screen module 210; and

$$If G ( m , n ) < T , then H ( m , n ) = 0 ; \qquad ( 3 )$$

where T=a predetermined grayscale threshold value,
thereby preventing the pixel H (m, n) from passing the light through the LCD screen module 210.

As such, as shown in FIG. 9, each LCD pixel element H (m, n) may be turn on (shown as a 1 in the array H) or turned off (shown as a 0 in the array H) depending on whether or not the associated element H (m, n) includes any of the portion P1.

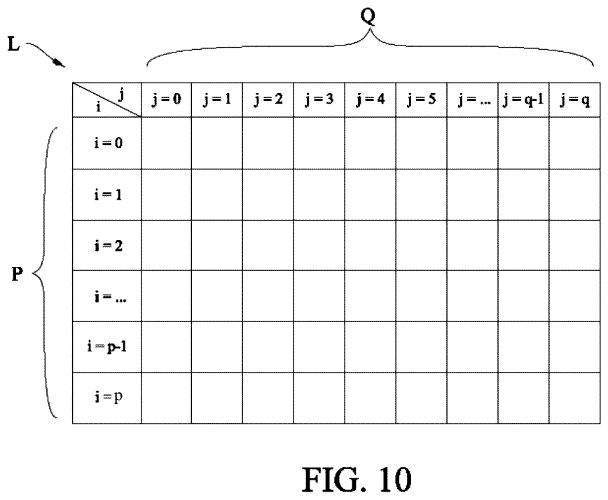

In some embodiments, the backlight assembly 100 also may be divided into pixel elements that may be dynamically controlled, with each LED pixel element generally including a single LED element 120, light guide 142, and lens 152 combination. For example, FIG. 10 shows an exemplary two-dimensional array L that may represent the array of LED elements 120 mounted to the base plate 110. In some embodiments, the array L may include dimensions P×Q based on the resolution of the LED elements 120 on the plate 110. For example, if the base plate 110 includes 112 LED elements 120 arranged in 14 rows of 8 elements each, P may equal 14 and Q may equal 8. It is understood that these example resolutions are for demonstrational purposes and are not limiting in any way.

In some embodiments, the factors F₁ and F₂ between the two-dimensional arrays H and L may be defined using the following:

$${F}_{1} = \frac{M}{P} and \qquad ( 4 )$$

$${F}_{2} = \frac{N}{Q} \qquad ( 5 )$$

Accordingly, it may follow that each LED element 120 may correspond to F₁×F₂ pixels on the LCD screen module 210.

In some embodiments, the light intensity of each LED element 120 (i.e., of each LED pixel element L (p, q) may be dynamically controlled by adjusting the power provided to the respective element 120 using the following:
[symbol] (6)
where PL (p, q) is the power provided to the LED element L (p, q), and
k=a predefined constant (e.g., a predefined convergence function).

It may be preferable that the predefined constant k be chosen to ensure that the light intensity provided by each LED element 120 (e.g., by each backlight cell C_{B}) may be adequate to cause a desired degree of resin curing in the region of the backlight cell C_{B} even if the portion P1 of the layer pattern within the cell C_{B} is small.

In some embodiments, the system 10 may normalize the grayscale values G (m, n) to obtain the following:
[symbol] (7)

In some embodiments, the power of an individual LED element 120 may then be determined, e.g., by using formula (6) above. By dynamically controlling the light intensity (e.g., the power) in various applicable regions of the array of LED elements 120, the boundary of the associated 3D-printed layer pattern may achieve varying degrees of curing which may result in smoother transitions at the boundaries of the respective layer pattern, thereby potentially reducing the surface texture of the 3D-printed part and enhancing the quality of the part's overall appearance.

In some embodiments, a binary control method may be implemented to dynamically control the LED elements 120. This approach may address potential under-curing issues, e.g., in the inner regions of a printed layer pattern.

The binary control function may include the following:

$$B ( p , q ) = \{ 1 , if L ( p , q ) > 0 ; 0 , if L ( p , q ) = 0 \} \qquad ( 8 )$$

where B(p, q) is the binary state (e.g., on/off state) of the LED element 120 at position (p, q), and
L(p, q) is the calculated percentage of LED power for the respective LED element 120 calculated using formula (6) above.

The above procedure may be implemented as follows:

First, the power of the particular LED element 120 may be calculated using formula (6) above.

Next, the binary control function of formula (8) above may be applied.

Next, the state of the particular LED element 120 may be controlled using the following:

$$LED\_State ( p , q ) = B ( p , q ) * Full\_Power \qquad ( 9 )$$

where Full_Power is the maximum power setting for the particular LED element 120.

The binary control method described above may provide several advantages, including but not limited to the following:

Simplicity: The binary control method may be implemented more simply and may require lesser complexity driver circuitry compared to other methods (such as variable power control methods).

Consistent curing: By fully activating each applicable LED element 120 (e.g., each element 120 that includes at least a portion of the layer pattern), all areas of the print may receive adequate curing light intensity. This may address potential under-curing issues in the inner regions of the printed layer pattern.

Sharp boundaries: Full power activation may lead to sharper boundaries between cured and uncured areas thereby benefiting printed objects that may require a high level of precision.

Power efficiency: As is known, LED elements may operate most efficiently when driven at their rated power, and the binary control method may ensure that the LED elements 120 are either off or at full power, thereby potentially improving the LED's overall energy efficiency.

Thermal management: The LED's thermal management may be simplified as the LED elements 120 are either fully on or fully off, thereby leading to predictable heat generation patterns.

In other embodiments, the power of each LED element 120 may be adjusted prior to the 3D printing process which may ensure that the light intensity reaching the underside of the LCD screen module 210 may be uniform and consistent. This calibrated power may serve as the baseline value. Based on the varying grayscale values of the layer pattern(s), the power of the LED elements 120 may then be dynamically adjusted to achieve the desired curing effect.

### Dedicated Lens 154

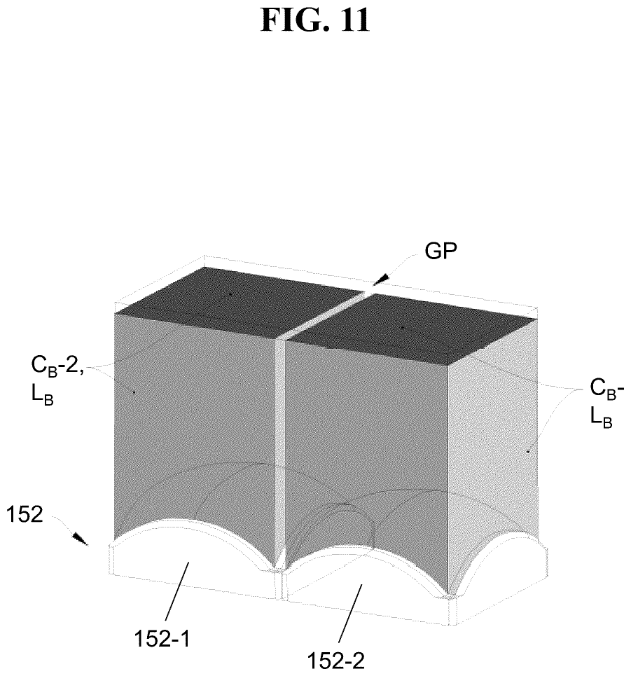

FIG. 11 shows two side-by-side backlight cells C_{B}-1 and C_{B}-2 comprising backlight L_{B} emanating from two corresponding side-by-side lenses 152-1, 152-2, respectively. As described herein, each of the backlight cells C_{B}-1, C_{B}-2 each may include predominantly collimated backlight L_{B} as shown.

In some embodiments, as shown in FIG. 11, a gap GP or spacing may exist between the side-by-side backlight cells C_{B}-1 and C_{B}-2, wherein the gap GP may include areas of insufficient and/or reduced back light L_{B} intensity that may in turn result in incomplete or insufficient curing of the 3D-printed object in these areas. Such gaps GP may lead to visible transition lines on the 3D-printed object, e.g., on the object's outer surface, thereby adversely affecting the quality and appearance of the object. As such, it may be preferable to eliminate and/or reduce these gaps GP.

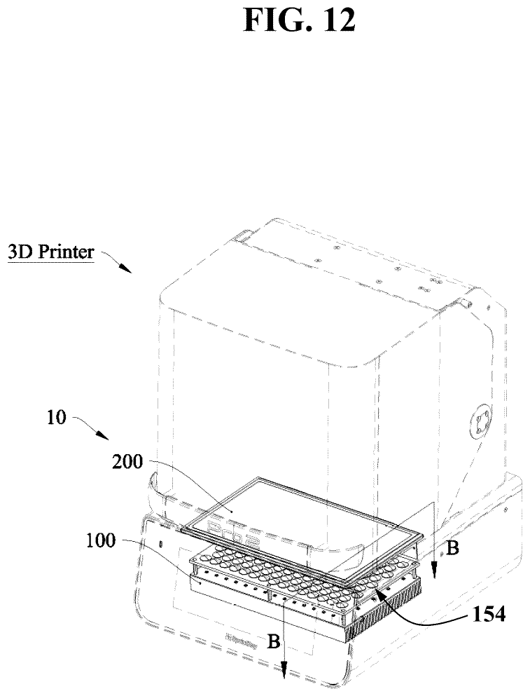

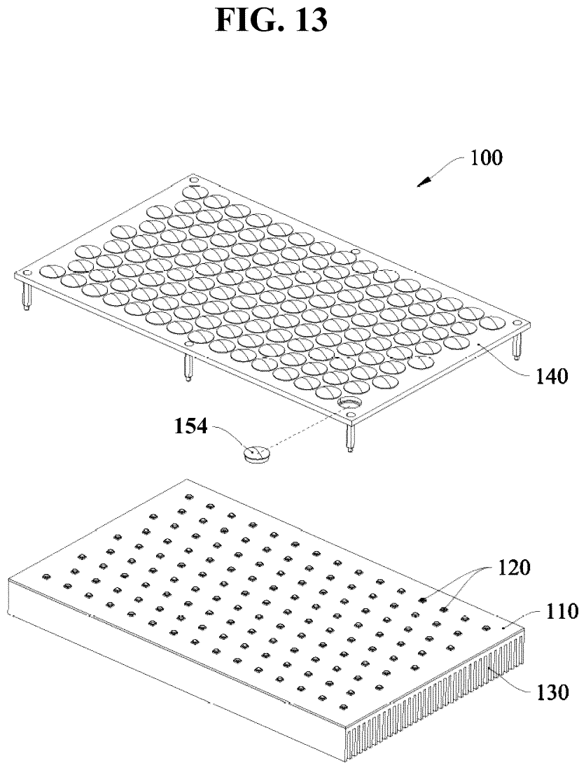

To address this potential issue, FIG. 12 shows an implementation of a dedicated lens 154 into the system 10, e.g., into a backlight assembly 100 implemented with an LCD assembly 200 and a corresponding 3D printer. FIG. 13 shows an exploded view of the backlight assembly 100, the lens 154, and the LCD assembly 200 for clarity.

In some embodiments, the dedicated lens 154 may generally correspond to the lens 152 and with one or more additional aspects as described herein.

In some embodiments, as shown in FIGS. 12 and 13, the lens 154 may be implemented into a baffle 140 (e.g., into a receiving slot within the baffle 140) arranged above a base plate 110 including one or more LED elements 120, e.g., similar to the arrangement described with reference to FIG. 3. It is appreciate that the implementation of the dedicated lens 154 into the backlight assembly 100 may be the same or similar to that of the lens 152 as described in other sections, and as such, some of the explanations regarding this configuration will not be duplicated here. However, it also is appreciated that the dedicated lens 154 may not be constrained to the exact same implementation(s) as the lens 152, e.g., the dedicated lens 154 may be integrated with a baffle 140 that may or may not include the one or more light guides 142, and instead, in some embodiments, the lenses 154 may be configured directly above the corresponding LED elements 120 to receive light therefrom without the corresponding light guides therebetween. Also, some of the dedicated lenses 154 may be configured with light guides while other dedicated lenses 154 may not. Furthermore, while the dedicated lenses 154 may be described herein as being individual discreet elements, it is understood that the dedicated lenses 154 may be integrated into a unitary lens module 150 which may be disposed on the baffle 140 as described in other sections. Using a unitary lens module 150 may allow for easier assembly and alignment of the optical components within the backlight assembly 100.

As shown in FIGS. 12 and 13, the components of the backlight assembly 100 may be arranged in a stacked configuration to provide proper alignment between the LED elements 120 and their corresponding optical lenses 154 when assembled. This arrangement may facilitate the controlled distribution of light from the LED elements 120 through the optical system and ultimately to the LCD assembly 200 positioned above. In addition, the base plate 110 may include one or more heat dissipating members 130, e.g., extending along one or more edges of the base plate 100 to regulate the temperature of the LED elements 120 and other components during operation.

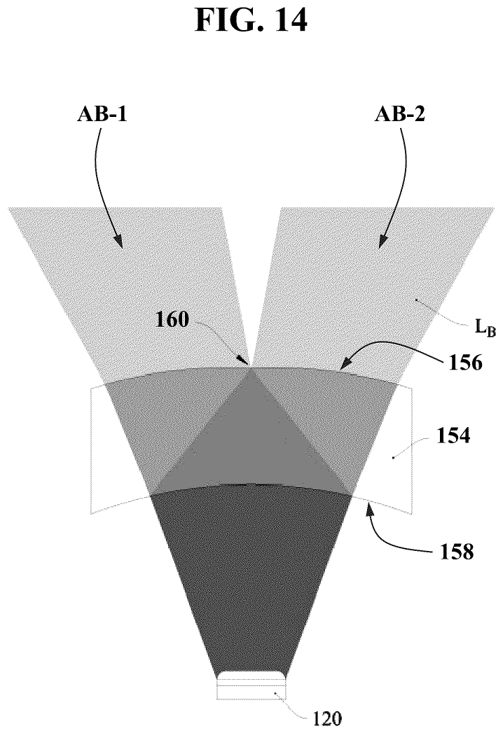

FIG. 14 shows a cross sectional view of a dedicated lens 154. In some embodiments, the lens 154 may include a lens body with a lens upper surface 156 and a lens lower or underside surface 158 generally opposite the lens upper surface 156. As described herein, and as shown in FIG. 14, the lens upper surface 156 and/or the lens underside surface 158 may each be designed to cause the back light L_{B} provided by the associated LED element 120 to at least partially diverge as it passes into the lens's underneath surface 158, through the lens 154, and out of the lens's upper surface 156. Furthermore, as described below, this divergence of light (also referred to as focusing effect) may create an annular light band AB of associated back light L_{B} that may at least partially, and preferably completely, fill the gaps GP with sufficient curing light. In this way, any potential transition lines caused by potential gaps GP may be reduced or eliminated.

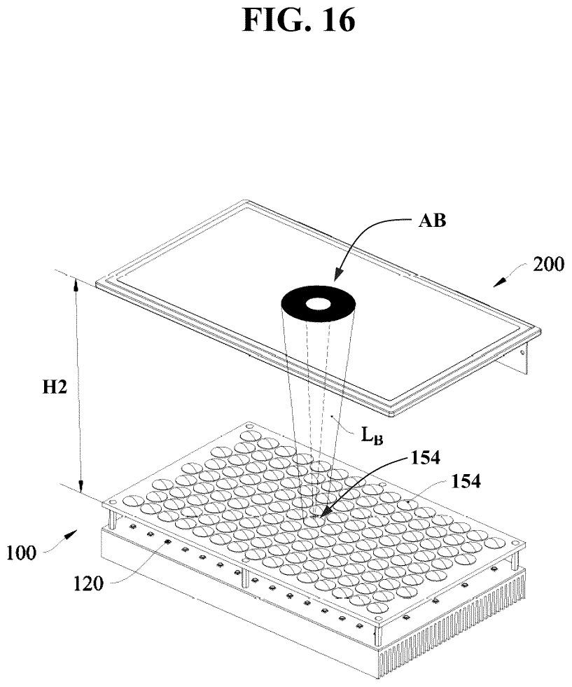

In some embodiments, as shown in FIG. 14, the lens's upper surface 156 may be generally convex and may include a central curvature variation, e.g., a recess 160 (e.g., a concave recess or central dimple) that may be designed to cause further outward divergence of the back light L_{B} emitting from the lens's upper surface 156. As shown, the central recess 160 may cause the light to be generally concentrated into outer annular band light portions AB-1 and AB-2 that when viewed in a three-dimensional depiction (e.g., see FIG. 16) may form the complete annular band AB. In some embodiments, the depth, width and curvature of the lens's central recess 160 may be chosen to adjust the amount of light divergence desired. In some cases, the central recess 160 may simply include a flattened portion of the lens 154 with less curvature. It also is contemplated that the recess 160 may be offset from the middle of the lens 154 to vary the location and/or shape of the resulting annular light band AB.

In some embodiments, as shown in FIG. 14, the lower or underside surface 158 of the lens 154 may be generally concave. Being concave, the lens's underside surface 158 also may cause the back light L_{B} passing through the lens 154 to diverge.

In some embodiments, the lens's underside surface 158 may include a higher curvature that that of the lens's upper surface 156. This difference in curvature may affect how the light is redirected and distributed as it passes through the optical lens 154.

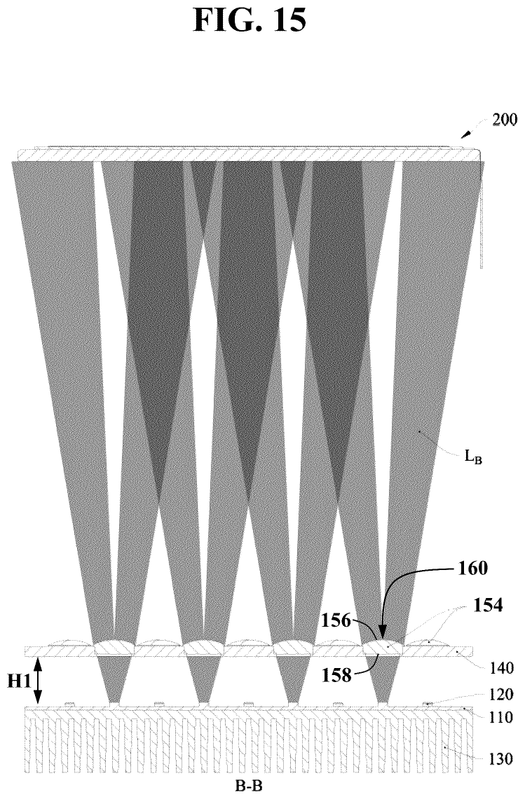

FIG. 15 shows a cross-sectional view along the cut-lines B-B of FIG. 12 showing the light path of the backlight L_{B} emitted from the LED elements 120 passing through the dedicated lenses 154. In some embodiments, as shown in FIG. 15, when the LED elements 120 are activated (i.e., turned on), the elements 120 may each emit divergent light (i.e., backlight L_{B}) preferably with an initial emission angle ranging from approximately −30° to 30°. The backlight L_{B} may then diverge further as it passes through the lenses 154 disposed on the baffle 140 and as the light travels to the lower surface of the LCD assembly 200. As shown, the backlight L_{B} emitted from multiple LED elements 120 may be superimposed and combined to form the lit radiation zone Z_{L} (see also FIG. 5). Through the superimposition of light intensity from adjacent LED elements 120 in the lit radiation zone Z_{L}, a uniform, consistent, and continuous backlight or lit radiation zone Z_{L} may be achieved. In some embodiments, the variation in light intensity within the radiation zone Z_{L} may preferably remain within ±5%.

FIG. 16 shows a perspective view of backlight L_{B} emanating from a dedicated lens 154 (and an associated LED element 120 beneath the lens 154) and being formed into the annular light band AB at the LCD assembly 200. As described, this annular light band AB may fill the gaps GP as described above.

It is appreciated that the annular light band AB shown in FIG. 16 is a visual representation of the phenomenon described above to provide clarity to this description. It also is appreciated that the annular light band AB may include generally concentrated higher-intensity light within the region of the band AB and with relatively lower-intensity light in the regions surrounding the band AB. That is, the annular light band AB may include lower-intensity light generally surrounded by higher-intensity light. Furthermore, while the annular band AB is depicted as a generally symmetrical ring or circle in FIG. 16, it is appreciated that the annular band AB may be formed as other shapes depending on the curvatures of the upper and lower surfaces 156, 158 of the dedicated lens 154, on the depth, width, curvature and location of the lens's central recess 160, and on other characteristics of the lens 154 and its positioning. For example, in some embodiments, the annular band AB may be formed as an oval, an ellipse, and/or other desired shapes.

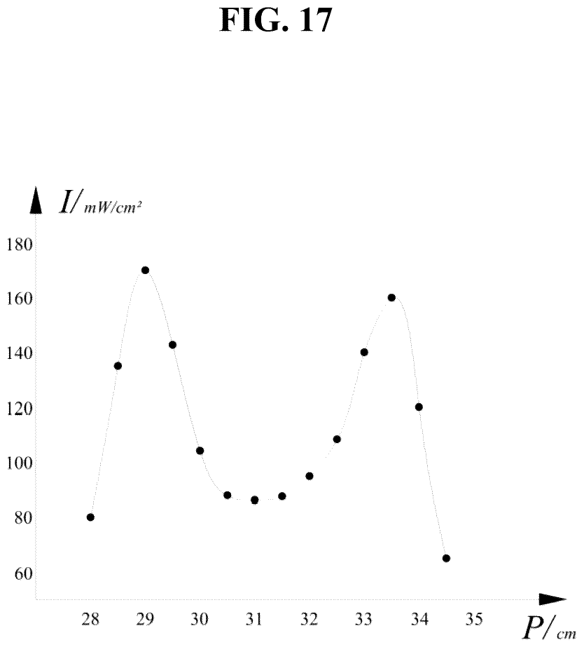

FIG. 17 shows a graph depicting the relationship between the light intensity and the position on the LCD assembly 200 when an LED element 120 located directly beneath the 31 cm position of the LCD assembly 200 is individually activated. As shown, the light intensity at the 31 cm position on the LCD assembly 200 (directly above the activated LED element 120) is generally at a minimum (e.g., in the middle of the corresponding annular light band AB) while the light intensity at positions to either side of the 31 cm position, e.g., at approximately 28.5-29.5 cm and 32.5-33.5 cm on the LCD assembly 200, are each generally at a maximum (in the outer ring portions of the annular light band AB). These left and right peaks also may generally correlate to the annular band light portions AB-1 and AB-2 of FIG. 14.

In some embodiments, the amount of divergence and therefore the resulting light intensity within the annular light band AB also may be at least partially dependent on the distance H1 between each LED element 120 and the underneath surface 158 of its corresponding lens 154 (see FIG. 15), and/or the distance H2 between the upper surface 156 of the lens 154 and the bottom surface of the LCD assembly 200 (see FIG. 16). As such, the curvatures of the lens's upper and lower surfaces 156, 158, the depth, width, curvature and location of the lens's central recess 160, and the distances H1 and H2 may be chosen to generally determine the size, intensity and other characteristics of the desired annular light band AB. This relationship between the lens's curvatures and its positioning may allow for fine-tuning of the light distribution pattern.

In the example provided in FIG. 17, an activation of a single LED element 120 arranged at distances H1, H2 may form an annular light band AB with a width of approximately 1 cm on the lower surface of the LCD assembly 200 as depicted in the graph.

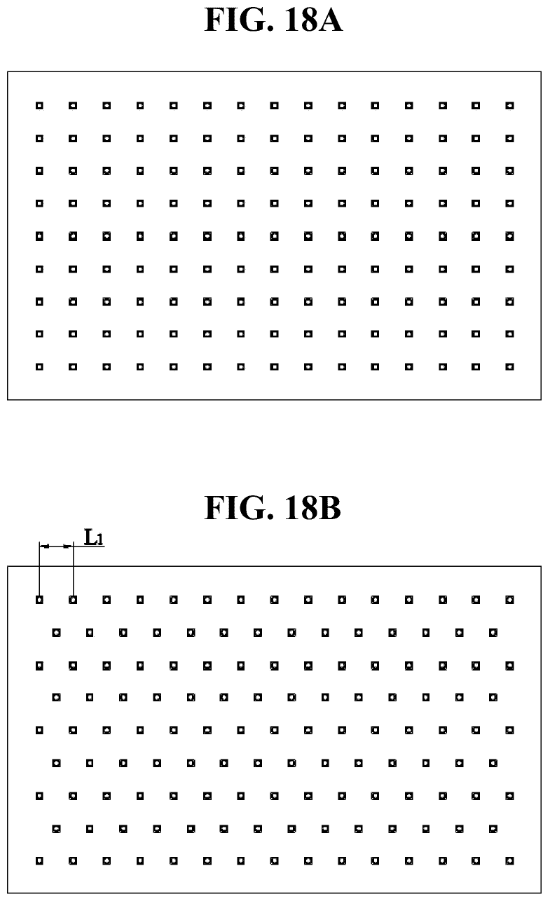

In some embodiments, as shown in FIGS. 18A and 18B, the LED elements 120 may be arranged in various array configurations, e.g., in a rectangular array as shown in FIG. 18A, and/or in a honeycomb array as shown in FIG. 18B with horizontal spacing L1 between adjacent LED elements 120. It is appreciated that these arrangements are for demonstration and that the elements 120 may be arranged in any other suitable arrangement(s) (e.g., in concentric circles and/or in any combinations thereof) to preferably achieve a uniform, consistent, and continuous backlight L_{B} or lit radiation zone Z_{L} on the LCD assembly 200. It also is appreciated that the lenses 154 may be preferably arranged in a manner to generally match the arrangements of the LED elements 120 so that each pair of corresponding elements 120, 154 may be properly aligned.

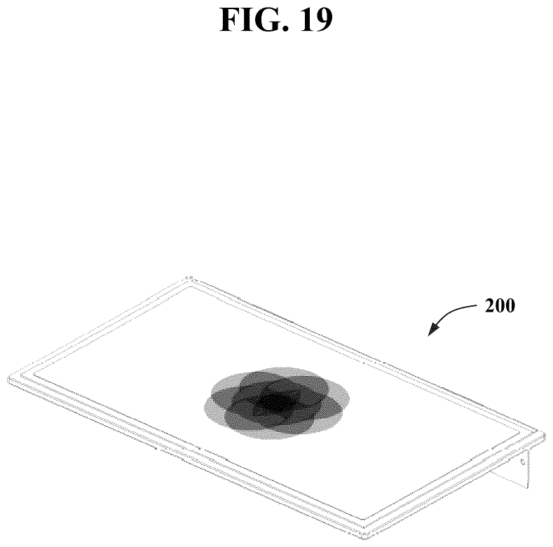

FIG. 19 shows a backlight L_{B} or lit radiation zone Z_{L} projected to the LCD assembly 200 resulting from an activation of a first LED element 120 and its six immediately adjacent LED elements 120, all arranged in a hexagonal arrangement within the honeycomb array arrangement of LED elements 120 depicted in FIG. 18B. As shown, in some embodiments, the honeycomb array arrangement of FIG. 18B may provide for a higher packing density of LED elements 120, and in particular, the honeycomb array may allow the light from the LED elements 120 to be uniformly superimposed from six directions resulting in the light pattern depicted in FIG. 19, thereby achieving a uniform, consistent, and continuous backlight L_{B} or lit radiation zone Z_{L}. Furthermore, the honeycomb array configuration may allow for efficient use of space within the backlight assembly 100, potentially enabling a greater number of LED elements 120 and corresponding optical lenses 154 to be incorporated within a given area. This increased density of light sources 120 may further enhance the uniformity of illumination across the target surface.

In some embodiments, the specific array configuration chosen for the LED elements 120 and optical lenses 154 may depend on factors such as the desired light distribution pattern, the size and shape of the backlight assembly 100, and the specific requirements of the 3D printing application.

In some embodiments, the lens 154 may comprise any suitable material(s) selected for their optical properties, such as transparency, as well as their ability to withstand the operating conditions within the backlight assembly 100. For example, in some embodiments, the lens 154 may comprise acrylic, heat-resistant glass, other suitable materials, and/or any combinations thereof.

As described in other sections, the backlight system 10 may be capable of dynamically controlling the operational status of each individual LED element 120. In some cases, this dynamic control may involve selectively activating or deactivating specific LED elements 120 within the backlight assembly 100. The ability to control individual LED elements 120 may allow for precise management of the light distribution across the LCD assembly 200. For example, certain regions of the LCD assembly 200 may be selectively illuminated by activating corresponding LED elements 120, while other regions may remain unilluminated by deactivating their corresponding LED elements 120.

This dynamic control capability may offer several potential benefits. In some implementations, it may allow for better management of power consumption within the backlight system 10. By activating only the necessary LED elements 120 for a given printing operation, energy efficiency may be improved.

Additionally, the dynamic control of LED elements 120 may contribute to extending the service life of the LCD assembly 200. By distributing the operational load across different LED elements 120 over time, wear on individual components may be reduced.

The combination of the precisely designed optical lenses 152, 154 and the dynamic control of LED elements 120 may work together to create a uniform, consistent, and continuous illumination across the LCD assembly 200. This uniform illumination may be crucial for achieving high-quality results in 3D printing applications that utilize the backlight system 10.

It is understood that any aspect or element of any embodiment of the system 10 described herein may be combined with any other aspect or element of any other embodiment of the system 10 to form additional embodiments of the system 10, all of which are within the scope of the system 10.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A light control system for use with three-dimensional printing systems, comprising:
a first lens including an upper lens surface and a lower lens surface;
a first light element configured to provide first light to the lower lens surface of the first lens;
a target surface arranged above the first lens to receive second light from the lens;
wherein the second light includes at least a portion of the first light that has been caused to diverge by the upper lens surface and/or by the lower lens surface;
wherein the second light at the target surface includes an outer portion of light surrounded by an inner portion of light, and wherein the outer portion of light has a higher light intensity compared to that of the inner portion of light.

2. The system of claim 1 wherein the outer portion of light completely surrounds the inner portion of light.

3. The system of claim 1 wherein the outer portion of light is formed as a ring of the higher-intensity light.

4. The system of claim 1 wherein the lens upper surface includes a convex curvature that causes at least some of the first light to diverge and to form at least a portion of the second light.

5. The system of claim 1 wherein the lens lower surface includes a concave curvature that causes at least some of the first light to diverge and to form at least a portion of the second light.

6. The system of claim 1 wherein the lens upper surface includes a recess that causes at least some of the first light to diverge and to form at least a portion of the second light.

7. The system of claim 1 wherein the lens upper surface includes a convex curvature with a concave recess that causes at least some of the first light to diverge and to form at least a portion of the second light.

8. The system of claim 7 wherein the recess is centrally located on the lens upper surface.

9. The system of claim 1 wherein the target surface includes an LCD display.

10. A light control system for use with three-dimensional printing systems, comprising:
one or more lenses each including an upper lens surface and a lower lens surface, each one of the one or more lenses paired with a corresponding light emitting element, each corresponding light element configured to provide first light to the lower lens surface of its corresponding lens;
a target surface arranged above the one or more lenses to receive second light from the one or more lenses;
wherein each one of the one or more lenses delivers a corresponding annular band of light to the target surface, and wherein the second light from the one or more lenses includes the annular bands of light from the each one of the one or more lenses.

11. The system of claim 10 wherein the annular bands of light from each one of the one or more lenses combine to form at least a portion of the second light.

12. The system of claim 10 wherein each of the upper lens surfaces includes a convex curvature that causes at least some of the first light to diverge and to form at least a portion of each lens's corresponding annular band of light.

13. The system of claim 10 wherein each of the lower lens surfaces includes a concave curvature that causes at least some of the first light to diverge and to form at least a portion of each lens's corresponding annular band of light.

14. The system of claim 10 wherein each of the upper lens surfaces includes a recess that causes at least some of the first light to diverge and to form at least a portion of each lens's corresponding annular band of light.

15. The system of claim 10 wherein each of the upper lens surfaces includes a convex curvature with a concave recess that causes at least some of the first light to diverge and to form at least a portion of each lens's corresponding annular band of light.

16. The system of claim 15 wherein each recess is centrally located on its corresponding upper lens surface.

17. The system of claim 10 wherein the target surface includes an LCD display.
